(19) United States
(12) Patent Application Publication
(10) Pub. No.: US 2015/0333458 A1
(43) Pub. Date: Nov. 19, 2015

(54) RELEASABLE PLUG CONNECTOR SYSTEM

(71) Applicants: MAGZET, LLC, Barberton, OH (US); ORCA CREATION PTE. LTD.

(72) Inventors: Jonathan Andrew Hallsten, Barberton, OH (US); Wan Muhamad Nur Zikri Bin Mat Daud, Johor (MY); Fong Kok Weng, Skudai (MY); Aw Keng Shing, Mantin (MY); Chon Peck Lian, Johor Bahru (MY); Lee Wee Thuang, Singapore (SG); Jeffrey A. Russell, Akron, OH (US)

(21) Appl. No.: 14/713,709

(22) Filed: May 15, 2015

Related U.S. Application Data
(60) Provisional application No. 61/994,550, filed on May 16, 2014.

(51) Int. Cl. H01R 24/58; H01R 13/62

(52) U.S. Cl. CPC H01R 24/58; H01R 13/6205; H01R 2105/00

(57) ABSTRACT

A connector system for connecting an audio cable to an audio player includes a plug having an insertion portion configured to insert into a jack of the audio player and an outside portion operatively connected to the insertion portion and configured to remain outside the jack of the audio player, the outside portion including electrical terminals electrically connected to respective contacts disposed on the insertion portion, the contacts including a detection contact that is divided into longitudinal electrically conductive segments electrically isolated from each other, and an adaptor having a mating portion configured to mate with the outside portion of the plug and a jack portion configured to receive a plug of the audio cable, the mating portion including a contact portion that mates with the detection contact of the plug to electrically connect the longitudinal electrically conductive segments to each other.

### FIELD OF THE INVENTION

The present disclosure relates to audio, video, data, power and other interface connectors for electronic devices and, more particularly, the present disclosure is directed to releasable, or break-away, connectors for coupling between electronic devices and their various interface connectors.

### BACKGROUND

Mobile phones, MP3 and other portable media players and electronic devices have become quite popular in recent years. For example, many people use the Iphone by Apple Computer, Inc., to listen to music. One of the most fragile aspects of the mobile phones and other media players is its audio jack and the internal connection circuitry of the player to which the audio jack is connected. The audio jack and the internal connection circuitry form a deep engagement within the player. Coupled with the protruding stem of the audio plug, which is normally covered by a plastic/rubber sleeve, a cantilever effect is unintentionally created when the audio plug and jack experiences a lateral, bending force, or when the cable of the headset is being tugged. However, when the audio plug and/or jack is excessively impacted or bent due to external forces, the abuse will damage the internal connection circuitry—eventually rendering the audio jack unusable.

Unfortunately, such abuses are not exclusive to music or media players; the hands-free plug and jack of mobile phones and laptop or desktop computers are equally vulnerable.

Certain manufacturers of mobile phones have proposed the use of customized “break-away” interface connectors; avoiding the use of typical audio plugs and jacks for audio connection to headsets. Laptop manufacturers such as Apple Computer have also introduced “break-away” power connectors called “MagSafe” to address the issue of damage to laptops due to impact or bending from typical power plugs. However, these custom connectors are specific to the device to which they are connected and cannot be used on other electronic devices that do not have matching receptacles.

It is desirable to have a releasable coupling connector that provides existing electronic devices with a “break-away” feature without the need for any modifications to the existing configuration or circuitry of the electronic device.

### SUMMARY

The present disclosure provides a connector system that includes a plug that will easily break-off from the jack of an electronic device such as a media player when impacted by an external force, especially a lateral and bending one without damaging the device. The connector system provides an intermediary interface with a break-away connector that is compatible with the existing jack of the media player, as well as the existing plug of the player's headset. The connector system may also be integrated with the cable of a headset or with the audio or media player.

The connector system causes the media player to not detect the presence of the headphones plug when the releasable adaptor is detached and detect the presence of the headphones plug when the releasable adaptor is reattached.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 is a perspective view of a connector system plugged into the audio device;

FIG. 1(a) and FIG. 1(b) is a perspective view of the break-away condition of the connector system after impacted by an external force;

FIG. 2 is a perspective view of the exemplary connector system;

FIG. 3 is a perspective view of a plug portion of the connector system of FIG. 2;

FIG. 3(a) is a cross-sectional view of the plug portion of FIG. 3;

FIG. 4 is an illustration of the plug after it has been separated into two parts;

FIG. 4(a) is a cross-sectional view of the separated plug of FIG. 4;

FIG. 4(b) is an enlarged view of the spring mentioned in FIG. 4(a);

FIG. 4(c) to FIG. 4(j) is an illustration of an exemplary manufacturing process for the plug of FIG. 4;

FIG. 5 is one of the plug contact exploded from the present plug of FIG. 1;

FIG. 5(a) and FIG. 5(b) is a zoomed-in view for the part in FIG. 5;

FIG. 6 is a perspective view of a plug portion of the connector system of FIG. 2;

FIG. 6(a) and FIG. 6(b) is a cross-sectional view of the adaptor of FIG. 6;

FIG. 6(c) is an exploded view of the adaptor of FIG. 6;

FIG. 6(d) to FIG. 6(h) is an illustration of an exemplary manufacturing process for the adaptor;

FIG. 7 is a cross-sectional view of an embodiment of the plug and the standard audio jack of the audio device;

FIG. 7(a) is a cross-sectional view of an embodiment of the standard plug and the standard audio jack of the audio device;

FIG. 8(a) and FIG. 8(b) are cross-sectional views of FIG. 7 to show the contact area between plug contact and standard audio jack of the device;

FIG. 9 and FIG. 9(a) are cross-sectional views of FIG. 2 of the connector system;

FIG. 9(b) and FIG. 9(c) are cross-sectional views of FIG. 2 of the connector system, showing the details of an overlapping area for each spring-loaded contacts on adaptor side;

FIG. 10(a) illustrates the position of one of the plug contact and one of the adaptor contact before the engagement of the plug and adaptor;

FIG. 10(b) illustrates the position of one of the plug contact and one of the adaptor contact after the engagement of the plug and adaptor;

FIG. 10(c) is a cross-sectional view of the embodiment of the plug and adaptor as shown in FIG. 10(b);

FIG. 11 is another view angle of the FIG. 1;

FIG. 11(a) and FIG. 11(b) are cross-sectional views of FIG. 11;

FIG. 11(c) and FIG. 11(d) is a zoomed-in view for the part in FIG. 11(b);

FIG. 11(e) is a zoom-in view of FIG. 11(a) to show details the angle edge of the adaptor.

### DETAILED DESCRIPTION

The releasable, or “break-away” connector system as configured in accordance with the present invention is directed to electronic devices such as mobile phones, MP3 players, laptop or desktop computers, gaming consoles or other media players, where an audio jack is used for connecting the media player to the headset's plug. The releasable connector system could be either an add-on coupling connector between a conventional audio jack and a conventional headset, or an integrated segment for the audio plug of the headset or the audio jack of the audio player. One of the main advantages is to allow the coupling connector to detach from the audio jack when the coupling connector experiences a lateral force or impact so as to protect the internal connection circuitry of the media player. The other advantages is the plug can be remained to the device while the headset not in use to act as a dust cover to prevent the debris from entering the audio jack.

In the description that follows, instead of specifying “media,” “audio,” “video,” “data,” or “power,” reference will be made to “audio” and “audio device” or “audio player” or “media player” for simplicity. However, it should be apparent to those of ordinary skill in the art that all interface connectors that are susceptible to accidental impact or other damaging forces such as “audio,” “video,” “power” or “data” connectors can readily take advantage of the present invention.

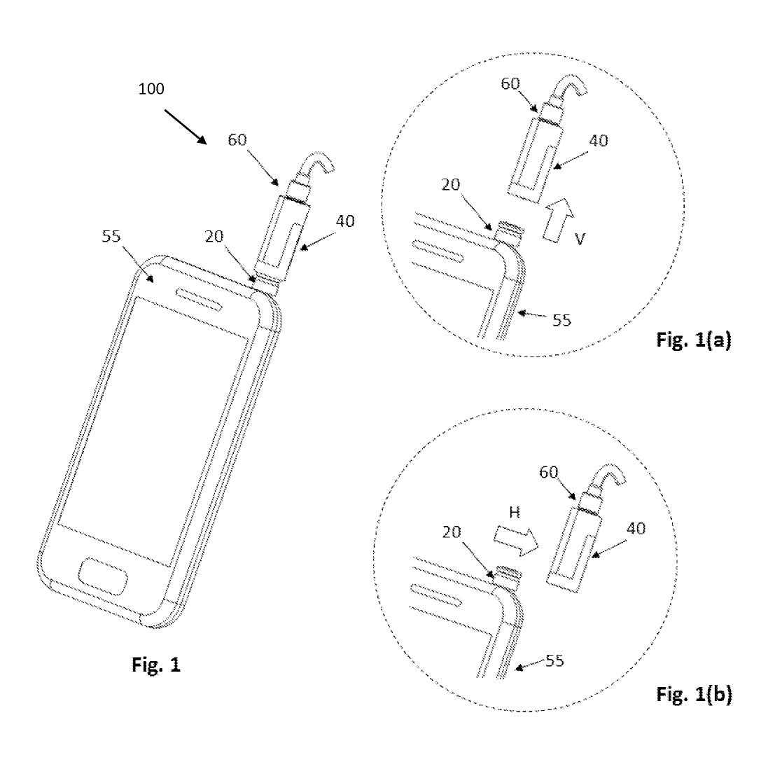

FIG. 1 illustrates a perspective view of an exemplary connector system 100. The system 100 includes the plug 20 that plugs into the device 55. The system 100 also includes the adaptor 40. A plug 60 from a standard headset plugs into adaptor 40 and the adaptor 40 mates with the plug 20 to complete the connection of the plug 60 to the device 55.

FIGS. 1(a) and 1(b) illustrate the break-away characteristic of the invention, adaptor 40 being inadvertently disconnected from the plug 20 by an external force on the direction V, and the direction H, respectively.

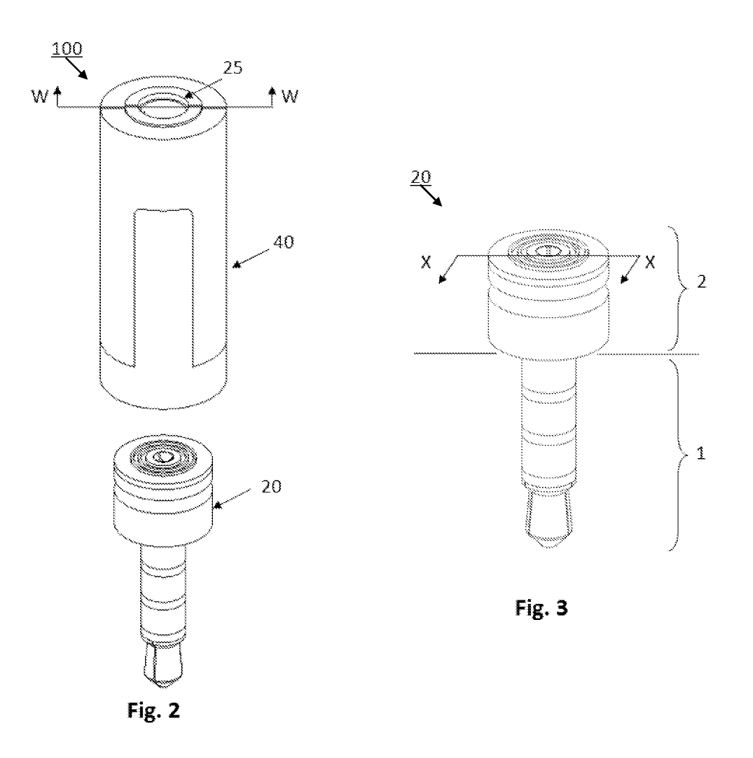

FIG. 2 illustrates another perspective view of the exemplary connector system 100. In the illustrated embodiment, the adaptor 40 includes an opening 25 configured to accept the standard plug 60 from a conventional headset. The plug 60 may be, for example, a plug that includes four conductors (i.e., left and right audio channel, microphone and ground). The plug 60 may also be, for example, a plug that includes three conductors (i.e., left and right audio channel, and ground) or less than three or more than four conductors.

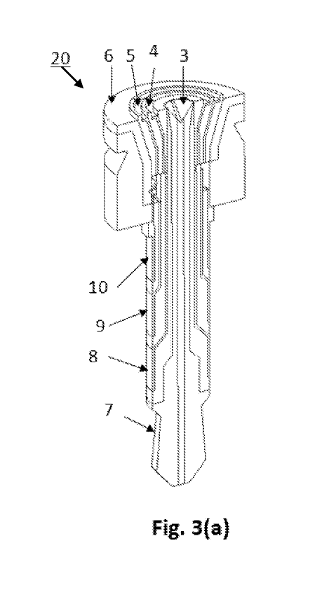

FIG. 3 illustrates a perspective view of the exemplary plug 20. The audio plug 20 includes two sections: section 1 and section 2. Section 1 represents the insertion portion of the audio plug 20 that is to be inserted into an existing audio jack of a media player, as further described herein. Section 2 represents the outside portion of the audio plug 20 that remains on the outside of the existing audio jack of the media player after section 1 is inserted.

FIG. 3(a) illustrates a cross sectional view of the exemplary audio plug 20 of the connector system 100, taken along line X-X of FIG. 3. The cross section of the audio plug 20 illustrates a plurality of terminals-contacts 3-7, 4-8, 5-9 and 6-10. The detection contact 3-7, for example, extrudes from the top contact 3 of the plug 20 to the bottom contact 7. Similarly, the contact 4 extrudes from the top of the plug 20 to the bottom contact 8, and so on. The contacts 7, 8, 9 and 10 may be fabricated of, for example, brass material with nickel plating at the section 1. The contacts 3, 4 and 5 may be made of, for example, brass material with nickel plating while the contact 6 may be made of, for example, ferrous material with nickel plating that allows it to releasably engage with the magnet 33 of the adaptor 40, as further described herein.

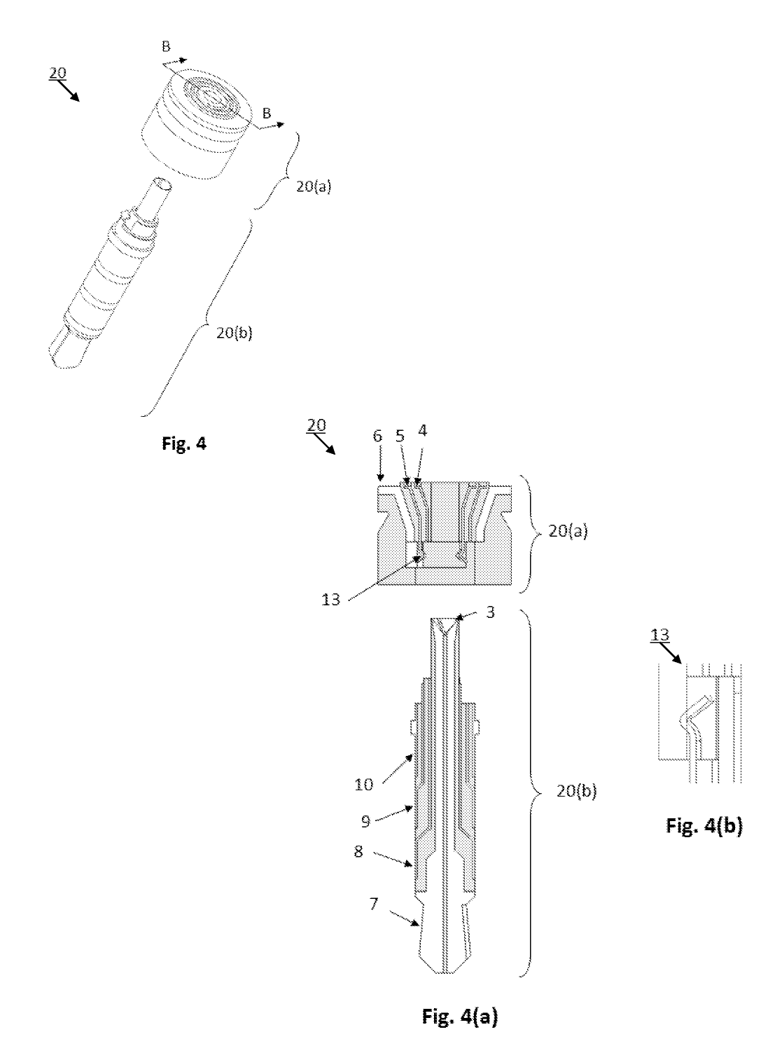

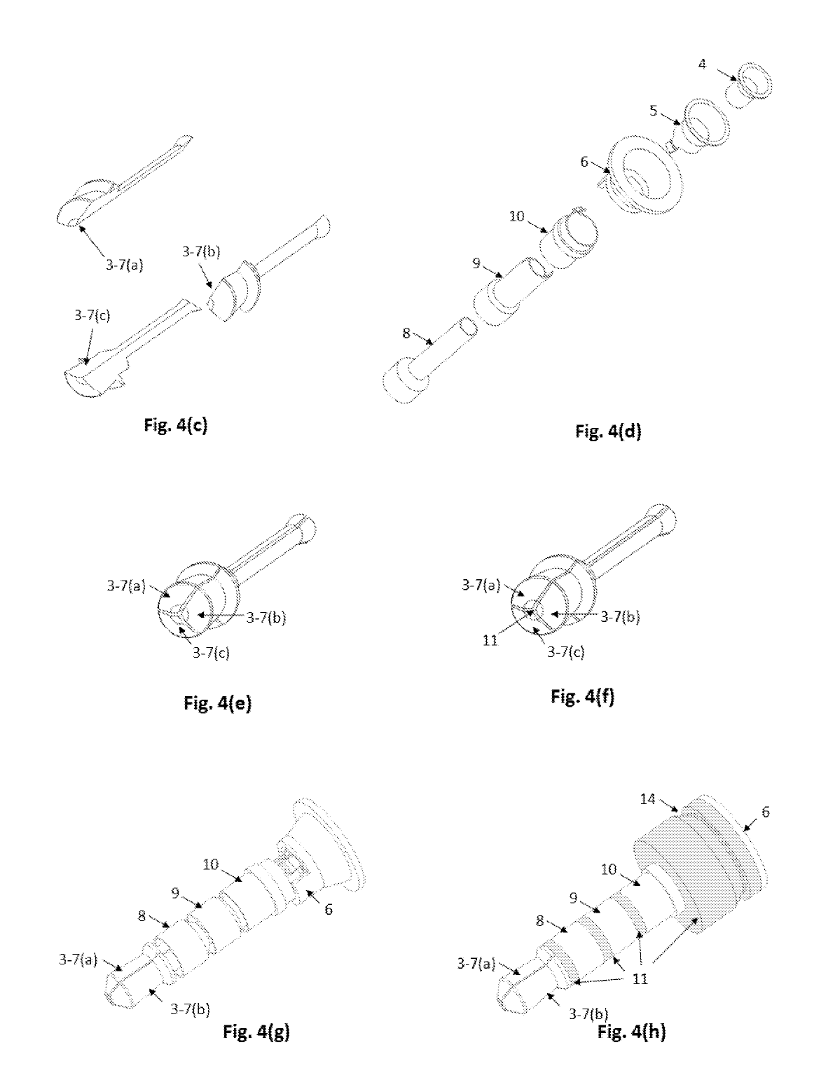

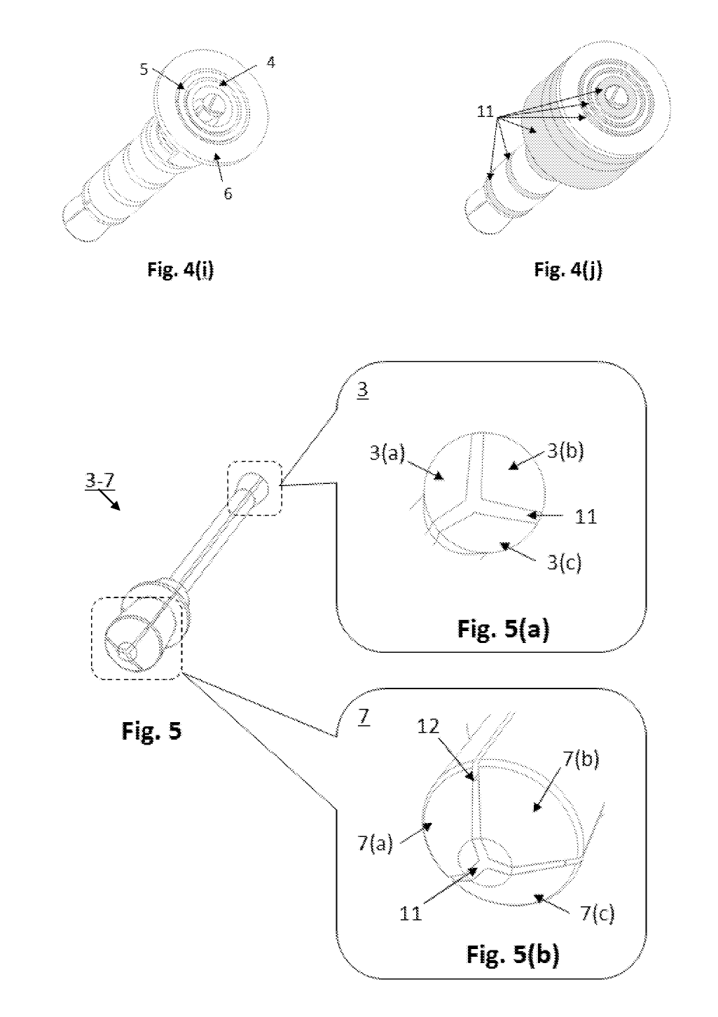

FIG. 4 illustrates an exploded view of the exemplary audio plug 20. The plug 20 is separated into two separate parts, plug top 20(a) and plug bottom 20(b).

FIG. 4(a) illustrates a cross sectional view of the exemplary plug 20 separated along the line B-B of FIG. 4. FIG. 4(b) illustrates a zoomed-in view particularly illustrating the spring 13 from FIG. 4(a). The spring 13 attaches to either the contacts 4 or 7, 5 or to the contacts 8 and 6 or 9, to ensure that electricity transfers smoothly between the contacts 4, 5 and 6, and the contacts 7, 8 and 9. In the illustrated embodiment, the diameter of the contact surface of the contact 3-7 is smaller than the inner diameter of the next barrel, 4-8. The outer diameter of the contact surface of this barrel also has to be smaller than the inner diameter of the next barrel, and so on.

FIG. 4(c) to FIG. 4(j) illustrate an exemplary manufacturing process for producing the plug 20. FIG. 4(c) illustrates an exploded view of the barrel or detection contact 3-7. The detection contact 3-7 is divided into longitudinal electrically conductive segments 3-7(a), 3-7(b) and 3-7(c) electrically isolated from each other. FIG. 4(d) illustrates the separate parts of the other contacts 4, 5, 6, 8, 9 and 10 before the parts have been attached to the contact 3-7 as shown on FIG. 4(g). Firstly, the separated contacts 3-7(a), 3-7(b) and 3-7(c) as shown on FIG. 4(c) may be positioned as shown on FIG. 4(e) before molding the part to result on the assembly illustrated on FIG. 4(f). Then, the separated contacts 4, 5, 6, 8, 9 and 10 as shown on FIG. 4(d) may be positioned as shown on FIG. 4(g) and molded to form a complete part as illustrated on FIG. 4(h). The isolator 11 shown in the FIG. 4(f), FIG. 4(h) and FIG. 4(j) is to illustrate the plastic material that keeps conductors such as, for example, 3-7(a), 3-7(b) and 3-7(c) electrically isolated from each other after the molding process. FIG. 4(i) is another view of FIG. 4(g) that shows details about the location of contacts 4, 5 and 6. FIG. 4(j) is another view of FIG. 4(h) to show details about the isolator 11 after the molding process.

Although in FIGS. 4(a) to 4(j) the terminal-contact 3-7 is shown as divided into longitudinal electrically conductive segments, in other embodiments any one or more of the terminals-contacts (e.g., 4-8, 5-9, and 6-10) may be divided into longitudinal electrically conductive segments to serve as a detection contact.

In the illustrated embodiment, the electric contacts 3, 4, 5 and 6 are planar and arranged in concentric circles. So, the electricity can be transferred from the adaptor 40 to the plug 20 although the adaptor rotates in any angle (360 degrees). Section 1 is dimensioned so that it may receive a conventional jack from the device 55. Section 2 preferably has a wider diameter than section 1.

FIG. 5 illustrates the exemplary contact 3-7 of the plug 20. The contact 3-7 is divided into at least three portions. In this example, the contact 3-7 is divided into three portions 3(a), 3(b) and 3(c) and 7(a), 7(b) and 7(c) in the angle of 120° which can be clearly seen from FIG. 5(a) and FIG. 5(b). Each portion or segment is separated an electrically isolated by the non-conductive material, isolator 11. The isolator 11 is slightly low level 12 compared to the contact 3-7 as show in the FIG. 5(b).

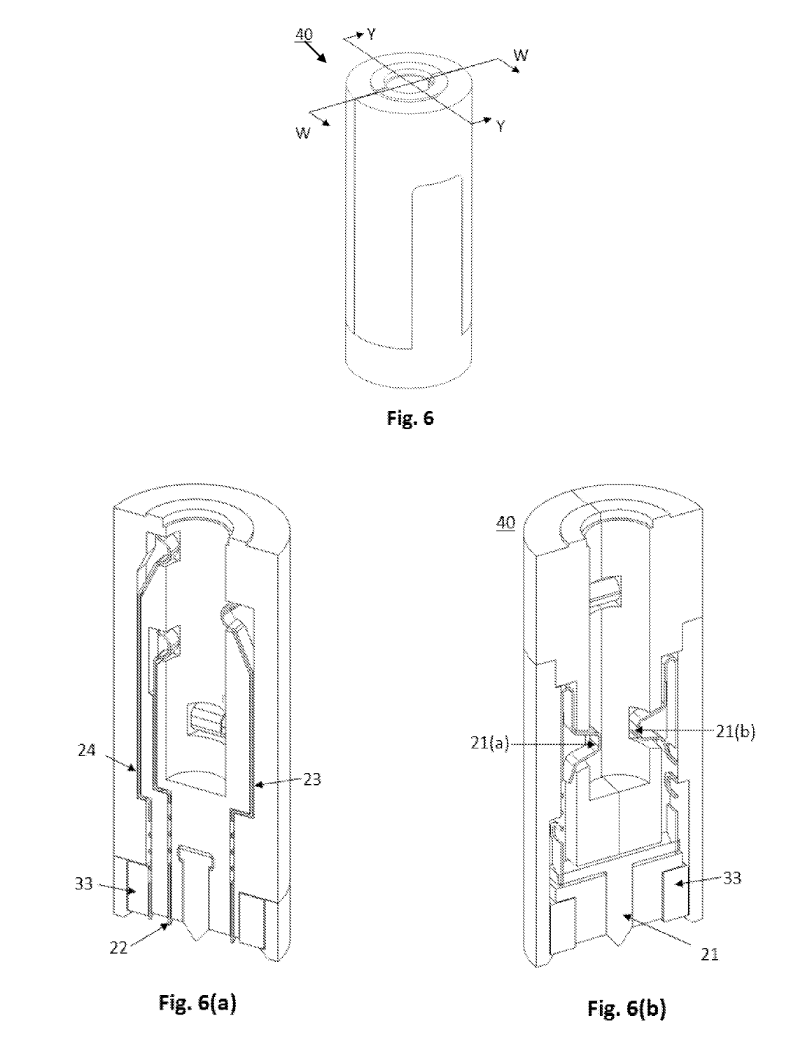

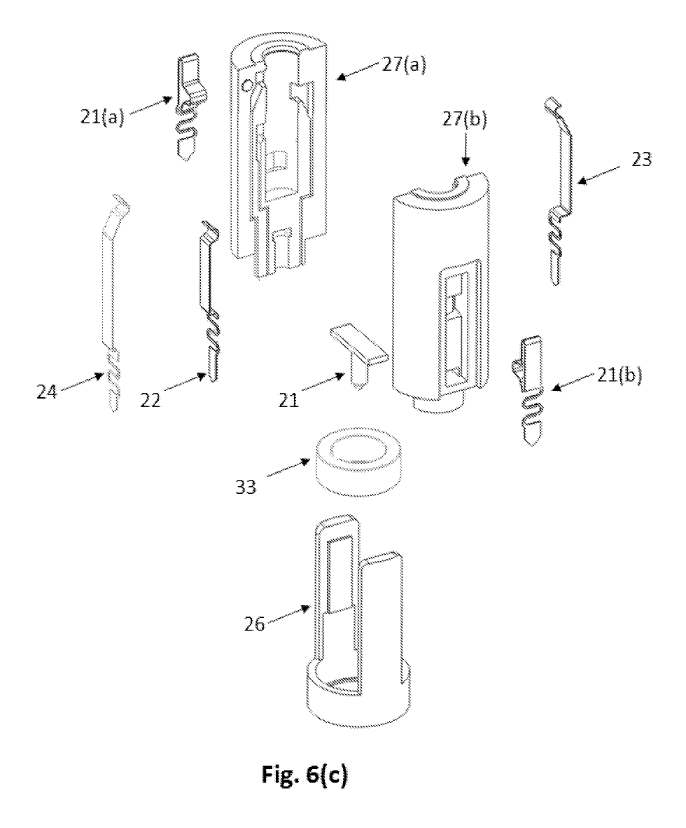

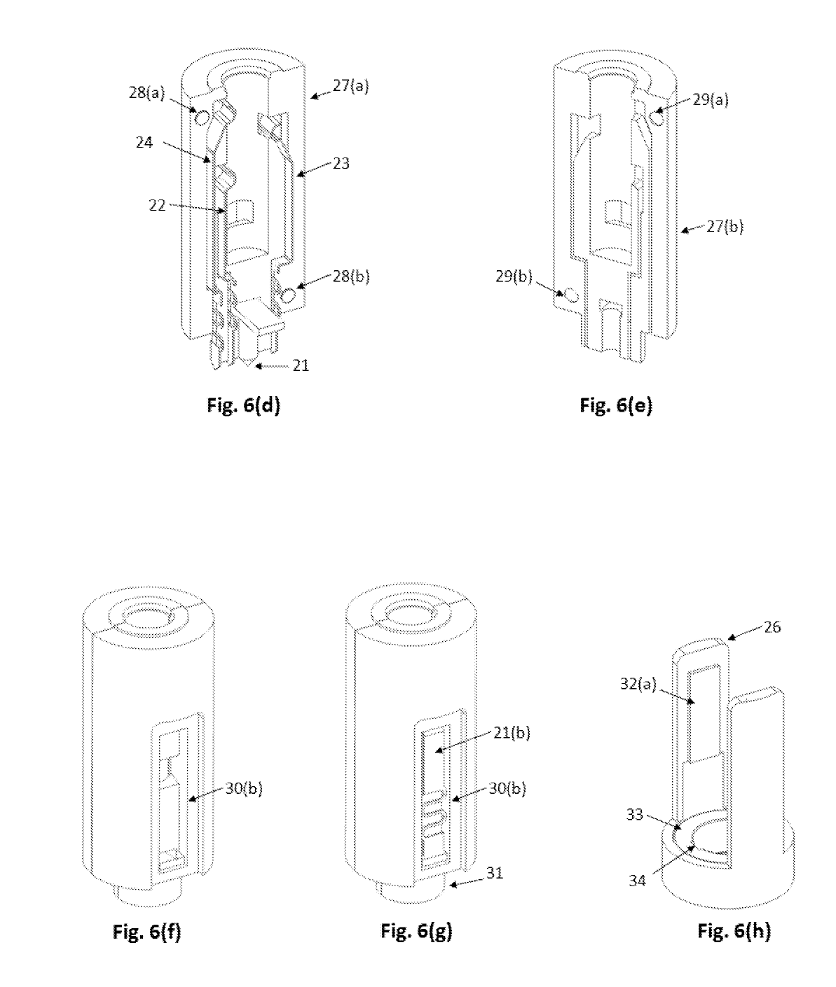

FIG. 6 illustrates a perspective view of the exemplary adaptor 40. FIG. 6(a) illustrates a cross sectional view of the adaptor 40 taken along line W-W of FIG. 6. It shows the construction of spring loaded contact 22, 23 and 24. FIG. 6(b) illustrates a cross sectional view of the adaptor 40 taken along line W-W of FIG. 6. The cone contact 21 has a conical shape to better snap to the plug 20. It is connected to the two spring-loaded contacts 21(a) and 21(b) inside the adaptor 40. The cone contact 21 and plurality of spring-loaded electric contacts 22, 23 and 24 may be made of, for example, brass material with nickel plating. FIG. 6(c) illustrates an exploded view of an adaptor 40 according to an embodiment of the present invention.

FIG. 6(d) to FIG. 6(h) illustrate an exemplary assembly method for the adaptor 40. Initially, all the contacts, cone contact 21, spring-loaded contacts 22, 23, 24 may be fixed to the first housing 27(a) as shown on FIG. 6(c) and FIG. 6(d). Then, as shown on FIG. 6(e) the second housing 27(b) may be matched to the previously assembled part using the guides, guide 28(a) to the guide 29(a) and guide 28(b) to the guide 29(b) and form the embodiment as shown on FIG. 6(f). Since the spring-loaded contacts 21(a) and 21(b) are perpendicular to the other contacts (spring-loaded contact 22, 23 and 24), they will be inserted to the first and second housing, 27(a) and 27(b) through the housing doors 30(a) and 30(b) as shown on FIG. 6(g). FIG. 6(f) and FIG. 6(g) only show one side of the adaptor 40 which is on second housing 27(b) side. The step of assembly the spring-loaded 21(a) is the same to the first housing 27(a) side which is through the housing door 30(a).

FIG. 6(h) shows the magnet 33 fixed to the cap 26 and then the combination of cap 26 and magnet 33 fixed to the spout 31 on FIG. 6(g) to complete the assembly of the adaptor 40. Based on FIG. 6(h), the magnet 33 has the cut off 34 to let the spring-loaded contact 24 go through and create contact with the contact 6. The protruding edge 32(a) is used to tightly hold the spring loaded contact 21(a) inside the housing door 30(a). On the other side of the cap 26 is protruding edge 32(b) to hold the spring-loaded contact 21(b) inside the housing door 30(b) which is not shown in the illustration.

It should be noted that in other embodiments of the present invention, the electric contacts 3, 4, 5 and 6, as disposed on section 2 of the audio plug 20, may be instead disposed on the adaptor 40, while the cone contact 21, spring-loaded contacts 22, 23 and 24 as disposed on the adaptor 40, may be implemented on the audio plug 20.

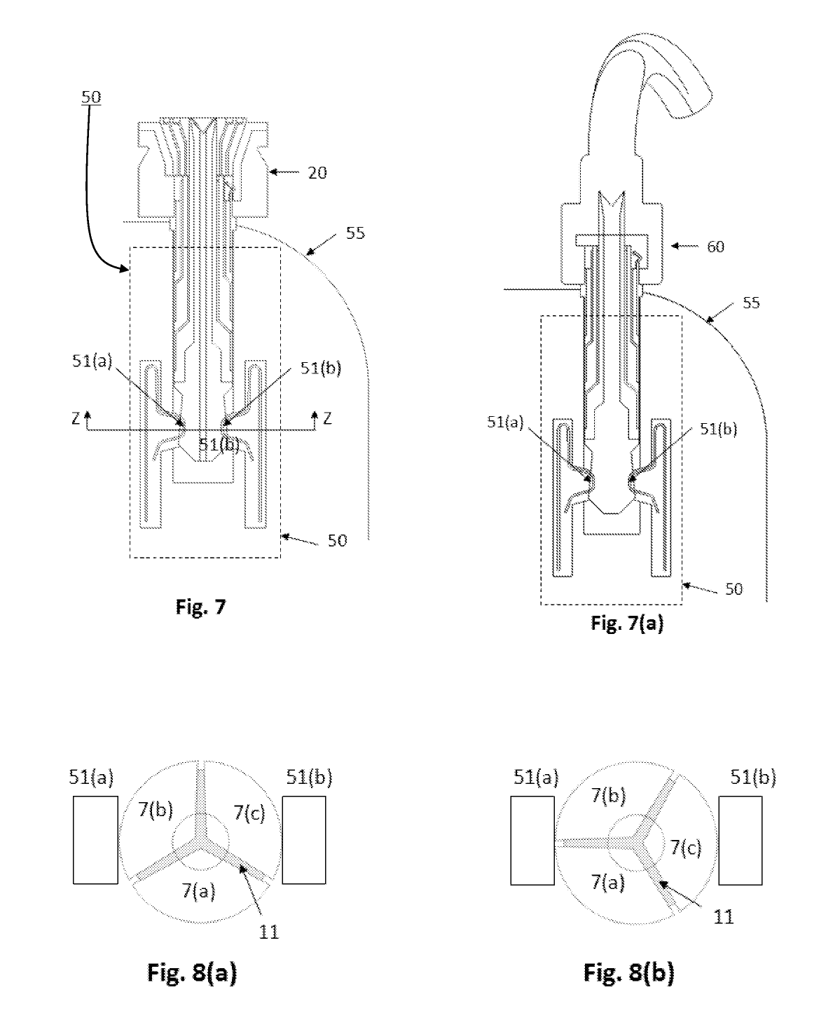

FIG. 7 illustrates a cross-sectional view of the plug 20 and the standard device jack 50 of the device 55. The device jack 50 detects the presence of a plug at the first contact points 51(a) and 51(b) which are located 180° to each other. If the standard plug 60 was plugged in into the standard device jack 50 as shown on the FIG. 7(a), electricity will travel from first contact point 51(a) or 51(b) to the other first contact point 51(a) or 51(b) by passing through the standard plug 60.

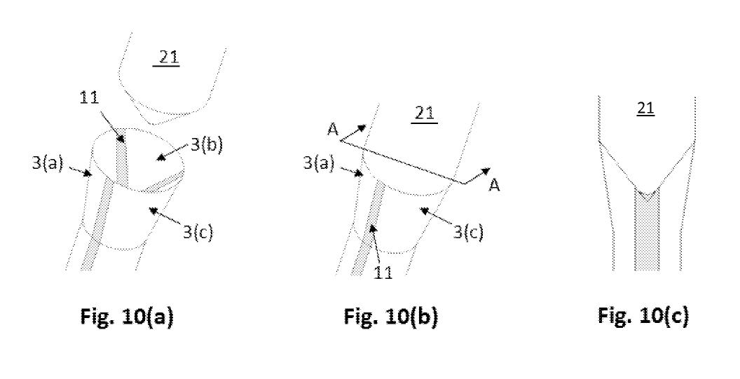

As shown in FIGS. 8(a) and 8(b), which are cross-sectional views of FIG. 7 taken along the line Z-Z, the first contact points 51(a) and 51(b) contact with the contact 3-7 at the point 7(b) and 7(c). Electricity cannot be transferred from first contact point 51(a) to 51(b) because 7(b) and 79(c) are separated by the isolator 11. As illustrated in FIG. 8(b), since the diameter of isolator 11 is smaller compared to the diameter of the point 7(a)-7(b)-7(c), the first contact point 51(a) may contact the points 7(a) and 7(b). The diameter of the isolator 11, purposely smaller than the diameter of the point 7(a)-7(b)-7(c), ensures that the first contact points 51(a) and 51(b) will always touch one or two of the points 7(a), 7(b) or 7(c) in any degree of the plug 20 insertion. To allow the electricity travel from the first contact point 51(a) to 51(b), the adaptor 40 must be connected to the plug 20. That will be explained on FIG. 10(a) to FIG. 10(c).

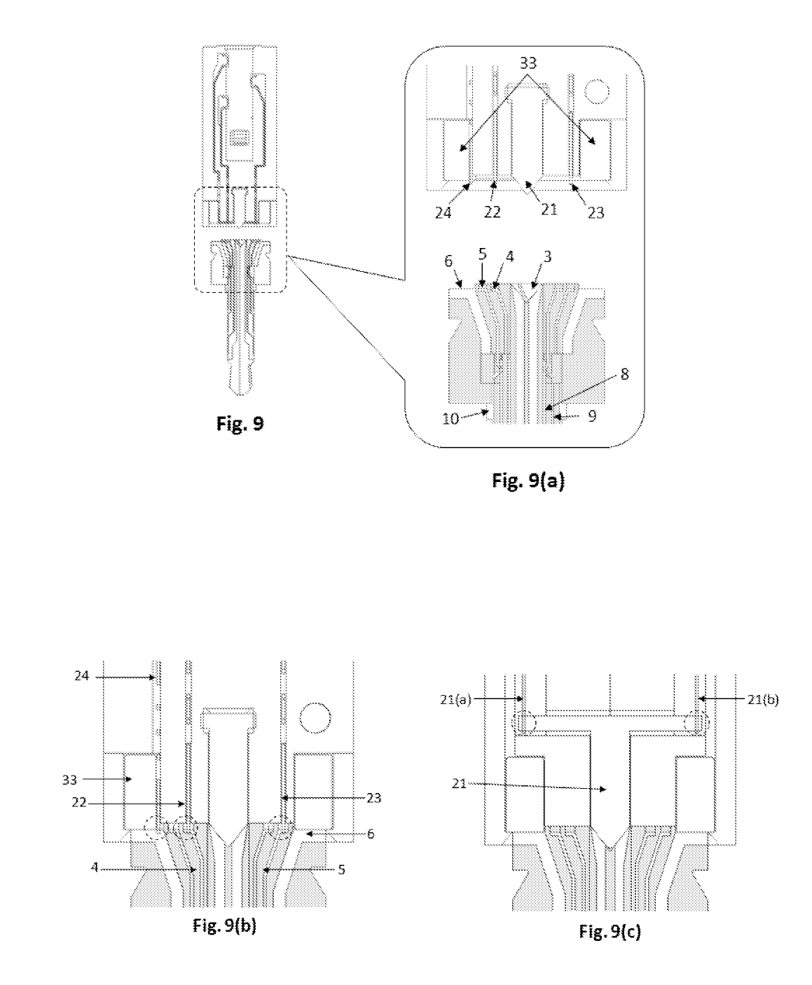

FIG. 9 is a cross sectional view of FIG. 2 taken along line W-W and it illustrates the connector system 100 prior to engagement between plug 20 and adaptor 40. A mating portion of the adaptor 40, where the contacts 21, 22, 23 and 24 are exposed, is configured to mate with the outside portion 2 of the plug 20. FIG. 9(a) is an enlarged view of FIG. 9. As may be seen from FIG. 9(a), the plurality of electric contacts 4, 5 and 6 may be designed in planar shape, and slightly wide to receive the spring-loaded contacts 22, 23 and 24 of the adaptor 40. The cone contact 21 may be designed in cone shape to create better contact with the contact 3 and at the same time simplify the alignment between adaptor 40 and plug 20.

In order to make sure the electricity may travel from one contact to the other contact, spring-loaded contacts at the adaptor 60 side may be designed to overlap with the next conductor attached to it. The overlapped area are shown marked with circle dotted lines in FIG. 9(b) and FIG. 9(c). Referring to FIG. 9(b) which is the cross-sectional view of adaptor 40 along line W-W of FIG. 6, during engagement, magnetic force pulls the contact 6 of the plug 20 and make the plug 20 and adaptor 60 stick together. Spring-loaded contact 22, 23 and 24 are compressed and contact with the contact 4, 5 and 6 at the plug 20 side. Referring to FIG. 9(c) which is the cross-sectional view of adaptor 40 along line Y-Y of FIG. 6, spring-loaded contacts 21(a) and 21(b) will be compressed and contact with the cone contact 21.

FIG. 10(a) illustrates the position of the contact 3-7 (containing portions 3(a), 3(b) and 3(c)) and the cone contact 21 before the engagement (refer to FIG. 9(a)). FIG. 10(b) illustrates contact 3-7 and cone contact 21 after the engagement. FIG. 10(c) is the cross-sectional view of FIG. 10(b) taken along line A-A. Since the cone contact 21 is one piece conductor part, when the cone contact 21 is attached to the contact 3-7, it will electrically join the portions 3(a), 3(b) and 3(c). As a result, referring to FIG. 8(a) and FIG. 8(b) the current can travel either from first contact point 51(a) or 51(b) to the other point and the audio player device will detect the presence of the plug 20.

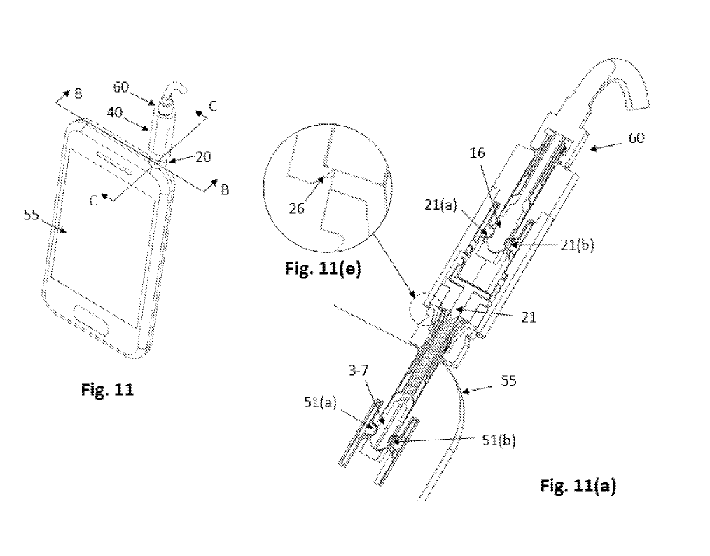

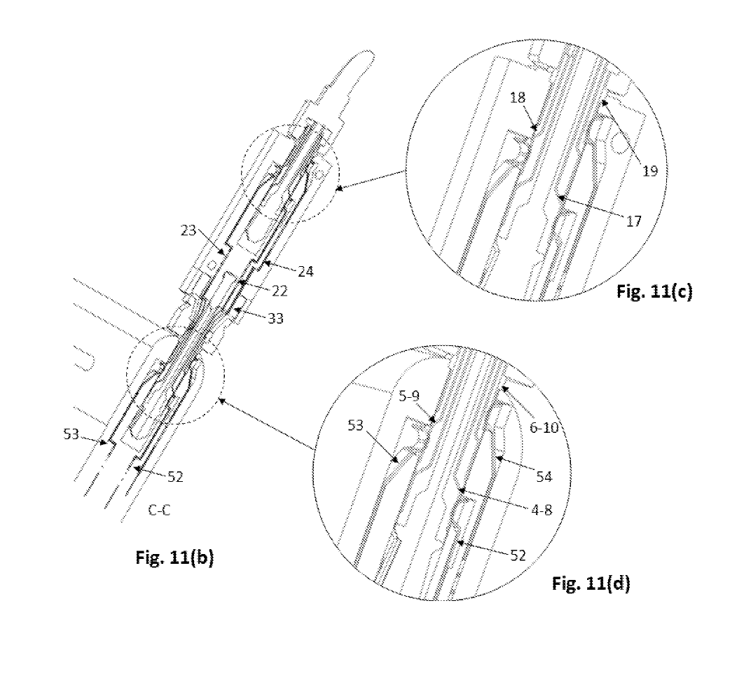

FIG. 11 is another view angle of the FIG. 1, to elaborate details of the travelling of the current from device 55 to standard plug 60. FIGS. 11(a) and 11(b) illustrate cross sectional views of FIG. 11 taken along line B-B and C-C, respectively. As may be seen from FIG. 11(a), electricity flows from the device 55 to the standard plug 60 in the route of, first contact point 51(a) and 51(b)→contact 3-7→cone contact 21→two spring contacts 21(a) and 21(b) 4 standard plug tip 16. It is the same for the other contacts 4-8, 5-9 and 6-10 as may be seen from FIG. 11(b), FIG. 11(c) and FIG. 11(d). Electricity flows from the device 55 to the standard plug 60 in the route of, second, third and fourth contact point 52, 53 and 54→plurality contacts 4-8, 5-9 and 6-10→spring-loaded contacts 22, 23 and 24→first ring 17, second ring 18, sleeve 19. FIG. 11(e) shows the opening of the adaptor 40 is designed at an angle 26 to ensure tangential forces can break away adaptor 40 from the plug 20 and not hold it too tight together.

During the use of the connector system 100, the standard plug 60 from the standard headset will be inserted to the adaptor 40 through the opening 25 based on illustration of FIG. 2. Based on the existing device study, force of the engagement between standard plug 60 and the device 55 may be approximately in the range 1.0 to 1.5 kgf. In one embodiment, the desired magnetic force of the engagement between plug 20 and the adaptor 40 of present invention may be around 0.5 kgf to make sure it is not easy to break-away and at the same time should not be bigger than the force of the engagement between standard plug 60 and the device 55. For example, in one embodiment, in order to achieve the holding force 0.5 kgf, the magnet 33 used is rare earth magnet grade N52. The outer diameter is 8.3 mm, inner diameter 5.3 mm and 3 mm in thickness. The other component of the adaptor change accordingly to be match with the size of the magnet 33.

While example systems, methods, and so on, have been illustrated by describing examples, and while the examples have been described in considerable detail, it is not the intention to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, and illustrative examples shown or described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A connector system for connecting an audio cable to an audio player, the system comprising:
a plug having an insertion portion configured to insert into a jack of the audio player and an outside portion operatively connected to the insertion portion and configured to remain outside the jack of the audio player, the outside portion including electrical terminals electrically connected to respective contacts disposed on the insertion portion, the contacts including a detection contact that is divided into longitudinal electrically conductive segments electrically isolated from each other, and
an adaptor having a mating portion configured to mate with the outside portion of the plug and a jack portion configured to receive a plug of the audio cable, the mating portion including a contact portion that mates with the detection contact of the plug to electrically connect the longitudinal electrically conductive segments to each other.

2. The connector system of claim 1, wherein the detection contact is divided into three or more longitudinal electrically conductive segments electrically isolated from each other.

3. The connector system of claim 1, wherein, where the audio player includes at least two electrical contacts that when not electrically connected to each other indicate to the audio player that the audio cable is not connected to the audio player and when electrically connected to each other indicate to the audio player that the audio cable is connected to the audio player, the detection contact being divided into the longitudinal electrically conductive segments that are electrically isolated from each other prevents the at least two electrical contacts from being electrically connected to each other when the insertion portion of the plug is inserted into the jack of the audio player while the mating portion of the adaptor is not mated with the outside portion of the plug.

4. The connector system of claim 1, wherein, where the audio player includes at least two electrical contacts that when not electrically connected to each other indicate to the audio player that the audio cable is not connected to the audio player and when electrically connected to each other indicate to the audio player that the audio cable is connected to the audio player,
the detection contact being divided into the longitudinal electrically conductive segments that are electrically isolated from each other prevents the at least two electrical contacts from being electrically connected to each other when the insertion portion of the plug is inserted into the jack of the audio player while the mating portion of the adaptor is not mated with the outside portion of the plug, and
the contact portion mating with the detection contact of the plug electrically connects the longitudinal electrically conductive segments to each other when the insertion portion of the plug is inserted into the jack of the audio player and the mating portion of the adaptor is mated with the outside portion of the plug.

5. The connector system of claim 1, wherein at least one of the outside portion of the plug and the mating portion of the adaptor includes at least one magnet to magnetically mate the outside portion of the plug to the mating portion of the adaptor.

6. An adaptor for connecting an audio cable to an audio player, the adaptor comprising:
an adaptor mating portion configured to mate with a mating portion connected to the audio player; and
a jack portion configured to receive a plug of the audio cable,
wherein the adaptor mating portion includes a contact portion that mates with a detection contact of the mating portion connected to the audio player to electrically close a circuit to indicate to the audio player that the audio cable is connected to the audio player.

7. The adaptor of claim 6, wherein, where the audio player includes at least two electrical contacts that when not electrically connected to each other indicate to the audio player that the audio cable is not connected to the audio player and when electrically connected to each other indicate to the audio player that the audio cable is connected to the audio player, the contact portion mating with the detection contact of the mating portion connected to the audio player electrically closing the circuit between the at least two electrical contacts electrically connects the at least two electrical contacts to each other indicating to the audio player that the audio cable is connected to the audio player.

8. The adaptor of claim 6, wherein, where the audio player includes at least two electrical contacts that when not electrically connected to each other indicate to the audio player that the audio cable is not connected to the audio player and when electrically connected to each other indicate to the audio player that the audio cable is connected to the audio player, the contact portion disconnecting from the detection contact of the mating portion connected to the audio player electrically opening the circuit between the at least two electrical contacts electrically disconnects the at least two electrical contacts from each other indicating to the audio player that the audio cable is not connected to the audio player.

9. The adaptor of claim 6, wherein, where the detection contact of the mating portion connected to the audio player is divided into three or more longitudinal electrically conductive segments electrically isolated from each other, the contact portion mating with the detection contact of the mating portion connected to the audio player electrically connects the three or more longitudinal electrically conductive segments.

10. The adaptor of claim 6, wherein the mating portion of the adaptor includes at least one magnet to magnetically mate the mating portion of the adaptor to the mating portion connected to the audio player.

11. A plug for connecting to an audio player, the plug comprising:
an insertion portion configured to insert into a jack of the audio player; and
an outside portion operatively connected to the insertion portion and configured to remain outside the jack of the audio player, the outside portion including electrical terminals electrically connected to respective contacts disposed on the insertion portion, the contacts including a detection contact that is divided into electrically conductive segments electrically isolated from each other.

12. The plug of claim 11, wherein the detection contact is divided into three or more electrically conductive segments electrically isolated from each other.

13. The plug of claim 11, wherein, where the audio player includes at least two electrical contacts that when not electrically connected to each other indicate to the audio player that audio cable is not connected to the audio player and when electrically connected to each other indicate to the audio player that the audio cable is connected to the audio player, the detection contact being divided into the electrically conductive segments that are electrically isolated from each other prevents the at least two electrical contacts from being electrically connected to each other when the insertion portion of the plug is inserted into the jack of the audio player while a mating portion of a device configured to mate to the outside portion of the plug is not mated with the outside portion of the plug.

14. The plug of claim 11, wherein, where the audio player includes at least two electrical contacts that when not electrically connected to each other indicate to the audio player that audio cable is not connected to the audio player and when electrically connected to each other indicate to the audio player that the audio cable is connected to the audio player,
the detection contact being divided into the electrically conductive segments that are electrically isolated from each other prevents the at least two electrical contacts from being electrically connected to each other when the insertion portion of the plug is inserted into the jack of the audio player while a mating portion of a device configured to mate to the outside portion of the plug is not mated with the outside portion of the plug, and
a contact portion of the mating portion of the device mating with the detection contact of the plug electrically connects the electrically conductive segments to each other when the insertion portion of the plug is inserted into the jack of the audio player and the mating portion of the device is mated with the outside portion of the plug.

15. The plug of claim 11, wherein the detection contact is divided into three or more longitudinal electrically conductive segments electrically isolated from each other.

16. A terminal for magnetically connecting an audio cable to an audio player, the terminal comprising:
a first mating portion configured to magnetically mate with a second mating portion at the audio player; and
a jack portion configured to receive a plug of the audio cable,
wherein the first mating portion includes a contact portion that mates with a detection contact of the second mating portion to electrically close a circuit to indicate to the audio player that the audio cable is connected to the audio player when the first mating portion and the second mating portion are magnetically connected.

17. The terminal of claim 16, wherein, where the audio player includes at least two electrical points that when not electrically connected to each other indicate to the audio player that the audio cable is not connected to the audio player and when electrically connected to each other indicate to the audio player that the audio cable is connected to the audio player, the contact portion mating with the detection contact of the second mating portion electrically closing the circuit between the at least two electrical points electrically connects the at least two electrical points to each other indicating to the audio player that the audio cable is connected to the audio player.

18. The terminal of claim 16, wherein, where the audio player includes at least two electrical points that when not electrically connected to each other indicate to the audio player that the audio cable is not connected to the audio player and when electrically connected to each other indicate to the audio player that the audio cable is connected to the audio player, the contact portion disconnecting from the detection contact of the second mating portion electrically opening the circuit between the at least two electrical points electrically disconnects the at least two electrical points from each other indicating to the audio player that the audio cable is not connected to the audio player.

19. The terminal of claim 16, wherein the first mating portion includes at least one magnet to magnetically mate the first mating portion to the second mating portion.

20. The terminal of claim 16, wherein, where the second mating portion is part of the audio player, the contact portion of the first mating portion mating with the detection contact of the second mating portion electrically closes a circuit in the audio player to indicate to the audio player that the audio cable is connected to the audio player.
